(19) United States
(12) Patent Application Publication
(10) Pub. No.: US 2012/0055764 A1
(43) Pub. Date: Mar. 8, 2012

(54) Control Device For Controlling Functions On A Motor Vehicle Control Panel And Corresponding Control Panel

(76) Inventors: Djamel Lekmine, Angervilliers (FR); Laurent Lucaora, Vanves (FR)

(21) Appl. No.: 12/999,514

(22) PCT Filed: Jun. 8, 2009
(86) PCT No.: PCT/EP09/57020

§ 371 Date: Nov. 23, 2011

(30) Foreign Application Priority Data
Jun. 20, 2008 (FR) FR08/03443

(51) Int. Cl. H01H 9/00; G05G 1/10

(52) U.S. Cl. 200/4; 74/504

(57) ABSTRACT

The present invention relates to a control device for controlling functions on a motor vehicle control panel, comprising a base (3), a control knob (5) mounted to rotate on the base (3) and able to collaborate with a base unit (12) intended to be connected to an equipment of the motor vehicle that is to be controlled, and a control member (7) mounted concentrically inside said knob (5), characterized in that said knob (5) comprises a grip ring (19) and a control drum (11) having, on the one hand, a peripheral skirt (17) collaborating with said ring (19) and, on the other hand, an axial tube (16) connected to said skirt (17) by a connecting bridge (18). The present invention also relates to a control panel for a motor vehicle, characterized in that it comprises at least one control device (1, 2) as previously described.

The present invention relates to a control device for controlling functions on a motor vehicle control panel suitable for being housed in a dashboard or in a fitted fascia panel of a motor vehicle. The invention also relates to a corresponding motor vehicle control panel. The invention applies more particularly to a control panel for controlling the air conditioning of a vehicle.

Already known according to FR-A-2 720 339 is a control panel for controlling a motor vehicle apparatus, for example a heating and/or air conditioning apparatus. In general, such a control panel comprises several control devices for regulating respectively the ventilation temperature, the distribution of the airflows and the intensity of the air ventilation inside the car interior.

The control devices that the control panel comprises may be, for example, rotary control members, control members of the push-key, hinged or flip-flop type.

The control devices must also comprise lighting means designed to illuminate chosen zones of the fascia panel in order to allow the driver or the passengers of the vehicle to identify said devices and their respective positions when driving at night.

Therefore, the control panels must have, in a reduced space, a certain number of devices performing specific functions, in particular of control and of lighting.

The known control devices notably have the drawback of having a complex structure which handicaps their manufacture in long runs on automated assembly lines.

Another drawback of these known control devices is that they are suitable, on each occasion, for a control panel of a given vehicle type which handicaps standardization.

Specifically, even though in theory one and the same control device could be used on various types of vehicles and for various controls, there are constraints, notably of space requirement and of integration into the dashboard, which mean that one and the same control device can be suitable for only one given type of control panel and vehicle.

Another problem arises from the fact that the control devices of one and the same control panel are suitable for a certain equipment level of a given vehicle and cannot be used in the same vehicle for another equipment level.

Therefore, for example, a control panel suitable for a heating device with no air conditioning cannot be suitable for controlling a heating device that is similar but fitted with the air conditioning option.

The main object of the invention is to overcome the aforementioned drawbacks by proposing a standardized control device and a panel, of simple structure, that can be used for various types of vehicles or for various equipment levels of one and the same vehicle type.

Accordingly, the invention proposes a control device for controlling functions on a motor vehicle control panel, comprising a base, a control knob mounted so as to rotate on the base and being capable of interacting with a base unit designed to be connected to an apparatus of the motor vehicle that must be controlled, and a control member mounted concentrically in said knob, characterized in that said knob comprises a gripping ring and a control barrel having, on the one hand, a peripheral skirt interacting with said ring and, on the other hand, an axial tube connected to said skirt by a connecting bridge.

According to one or more features of the control device taken in isolation or in combination,
said control barrel is made of a material transmitting light and the base comprises at least one lighting means, such as a light-emitting diode, for the backlighting of a display surface of the control device and for the generation of a circular diffuse light around the control member,
a display surface is supported by the control member and is backlit depending on the control selected by the control knob and/or by the control member,
the control member comprises an electric push switch,
the control member comprises an electric rotary switch,
the control knob comprises an adaptor mounted so as to rotate on a rotary shaft of the base, between the base and the barrel, configured to transmit the rotary movement of the barrel to the base unit,
the adaptor comprises a diverted guide that is inserted into an opening of the base so as to allow the adaptor to pivot by a pivoting movement of the diverted guide in the opening,
the control member comprises a support attached to the base, mounted concentrically in the control knob and having a display surface that can be backlit,
the axial tube has a first portion forming a means for guiding said knob in rotation by being inserted into a matching collar of the base,
the axial tube has a second portion formed by a narrowing of the first portion, configured either to be secured in rotation with a shaft of the base unit, or to allow a rotary shaft of the base to pass through,
the control knob and the control member comprise removable attachment means interacting with matching removable attachment means of the base.

A further subject of the invention is a control panel for a motor vehicle, characterized in that it comprises at least one control device as described above.

The control panel for a motor vehicle is for example designed for the control of air conditioning and comprises two first control devices according to a first embodiment, for the respective control of the ventilation temperature function and of the distribution of the airflows inside the car interior and at least one second control device according to a second embodiment, for controlling the intensity of the ventilation and of the air recycling mode.

Other advantages and features will appear on reading the description of the invention and in the appended figures in which:

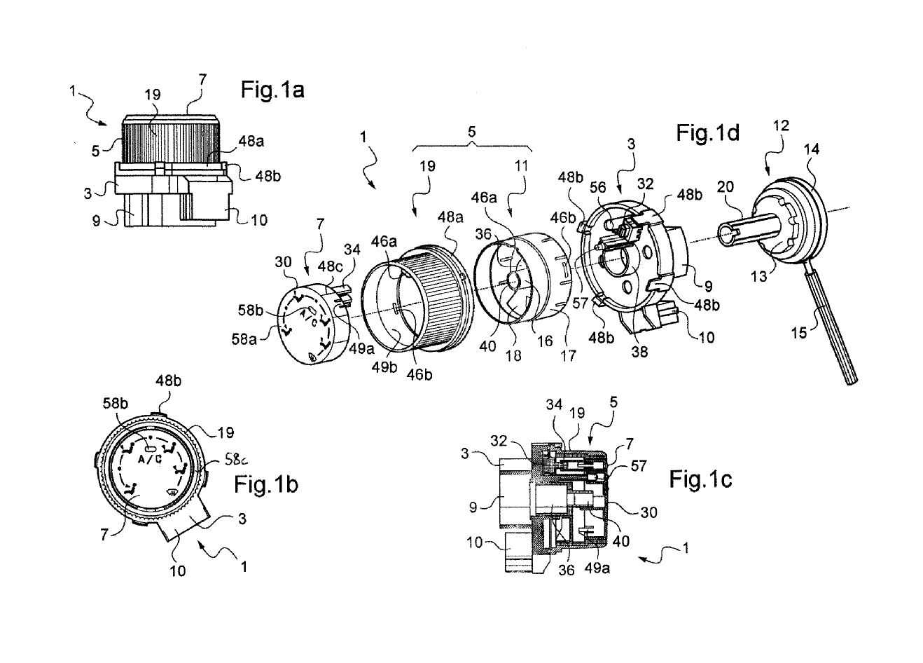

FIG. 1a is a side view of a control device according to a first embodiment in the assembled state,

FIG. 1b is a top view of the device of FIG. 1a,

FIG. 1c is a view in section along the line AA of the device of FIG. 1b,

FIG. 1d is a view in perspective of the control device of FIG. 1a in the disassembled state,

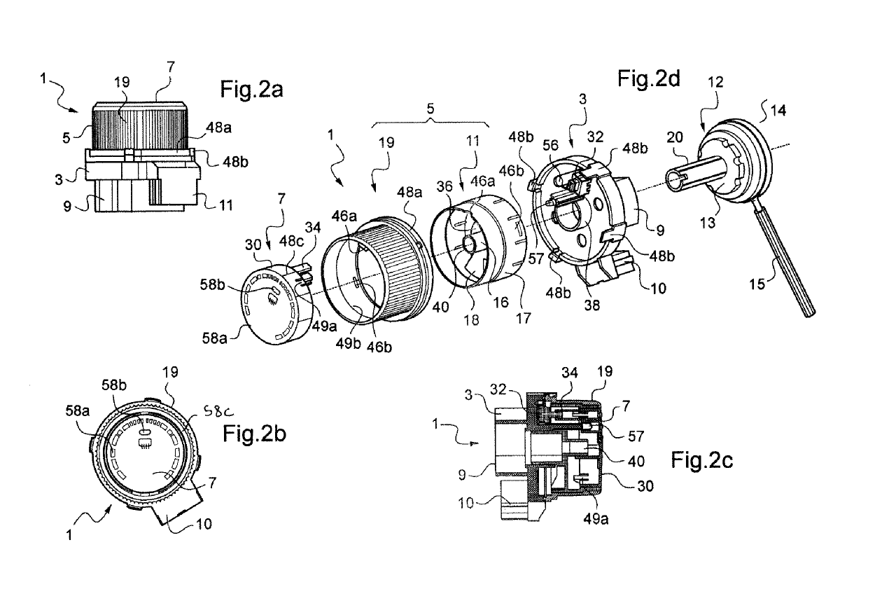

FIGS. 2a, 2b, 2c and 2d are similar views of another control device according to the first embodiment,

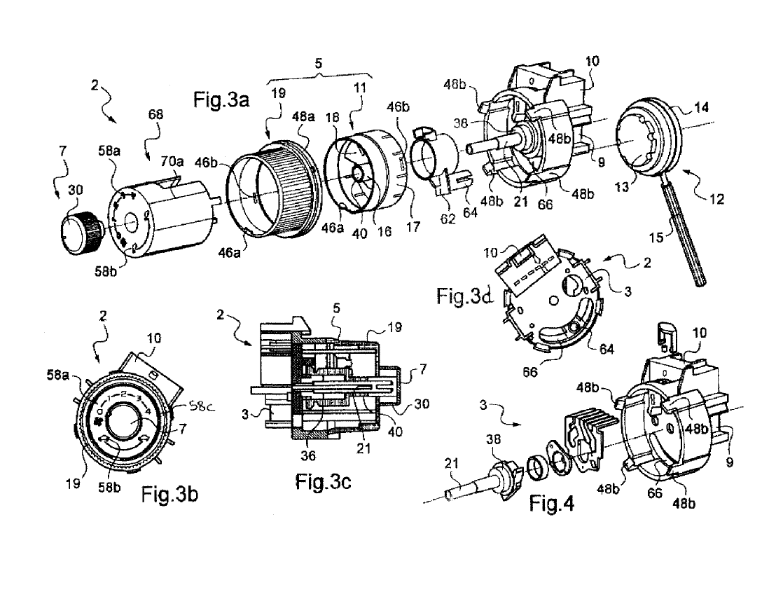

FIG. 3a is a view of a control device according to a second embodiment in the disassembled state,

FIG. 3b is a top view of the device of FIG. 3a in the assembled state,

FIG. 3c is a view in section along the line AA of FIG. 3b,

FIG. 3d is a bottom view of the device of FIG. 3b and,

FIG. 4 is a view in perspective of a disassembled base of the control device of FIG. 3a.

In these figures, identical elements bear the same reference numbers.

The present invention relates to a control device for controlling functions on a motor vehicle control panel suitable for being housed in a dashboard or in a fitted fascia panel of a motor vehicle. The invention also relates to a corresponding motor vehicle control panel.

The panel comprises for example three control devices of which two first devices 1 are configured according to a first embodiment for the respective control of the distribution of the airflows inside the car interior (FIGS. 1a to 1d) and of the ventilation temperature (FIGS. 2a to 2d) and a second device 2 is configured according to a second embodiment for controlling the intensity of the ventilation and of the air circulation mode (FIGS. 3a to 4).

FIGS. 1a to 1d illustrate a control device 1 produced according to a first embodiment.

The control device 1 comprises a base 3, a control knob 5 mounted so as to rotate on the base 3, for example by snap-fitting, and a control member 7 mounted concentrically in the knob 5.

The base 3 is arranged to be able to be mechanically attached to a control panel via attachment means 9. The base 3 also comprises an electric connector 10 so as to be able to be electrically connected to the control panel.

The control knob 5 is configured to interact with a base unit 12 designed to be connected to an apparatus of the motor vehicle (not shown) for example in order to be controlled by pulling a cable.

According to one embodiment, the base unit 12 comprises a rotary element 13, a base 14 and a cable 15, for example a Bowden cable. A left end of the cable 15 is attached to the base 14 while a right end can be moved with the rotary element 13 and is wound in the base 14. The other end (not visible) is designed to be connected to the apparatus to be controlled, for example to a flap of a heating-air conditioning apparatus.

Such a base unit 12 therefore allows a flexible mechanical control capable of transmitting remotely the movement applied to the rotary element 13.

The knob 5 comprises a gripping ring 19 and a control barrel 11 having, on the one hand, a peripheral skirt 17 interacting with the ring 19 and, on the other hand, an axial tube 16 connected to said skirt 17 by a connecting bridge 18.

The control member 7 may be of the electric and/or electronic type and is configured to be connected to an electric circuit, for example a printed circuit housed in the control panel.

The control member 7 of the control device 1 of the first embodiment comprises an electric push switch.

Electric push switches are switches that have a control shaft and in which the engagement of the switch is obtained by axially pushing the control shaft from the rest position into the switch as far as the engagement position where it is mechanically held in place.

When the switch is disengaged, the shaft is pushed axially into the switch beyond its engagement position in order to cause its disengagement and its automatic return to its initial rest position toward the outside of the switch, for example by a return spring.

The electric push switch shown in FIGS. 1a to 1d has a shaft connected to a button 30, interacting with a switch element 32, attached to the base 3.

The shaft has, for example, snap-fitting lugs 34 pinching the switch element 32 (see more particularly FIGS. 1a and 1c).

Moreover, the axial tube 16 of the barrel 11 has a first portion 36 forming a means for guiding the knob 5 in rotation by being inserted into a matching collar 38 of the base 3.

Moreover, a second portion 40 of the axial tube 16, formed by a narrowing of the first portion 36, is configured to be secured in rotation with a shaft 20 of the base unit 12.

Moreover, the second portion 40 also forms an axial guide for the button 30 of the control member 7.

Also, and as can be seen in FIG. 1d, the shaft 20 of the base unit 12 can be moved through an angle of 270°, thus defining at least seven angular positions of the control knob 5 corresponding to seven possible modes of distribution of the ventilation.

Pushing in the control member 7 therefore allows the user to switch the air conditioning on or off in the vehicle.

The barrel 11 can be attached removably to the thumbwheel 19, for example by snap-fitting means 46b and guidance means 46a so that the thumbwheel 19 and the barrel 11 are secured in rotation.

Moreover, the knob 5 and the control member 7 comprise removable attachment means interacting with matching attachment means of the base 3.

In the example illustrated by FIGS. 1a to 1d, the gripping ring 19 comprises a hopped element 48a interacting with corresponding snap-fitting arms 48b supported by the base 3.

Moreover, the control member 7 comprises grooves 48c interacting with corresponding ribs (not visible) supported by the base 3.

Furthermore, the control knob 5 is removably attached to the control member 7. In the example shown by FIG. 1a, the control member 7 comprises elastic hooks 49a interacting with a corresponding shoulder 49b of the gripping ring 19.

The control barrel is made of a material that transmits light, being for example transparent or translucent, and the base 3 comprises at least one lighting means, such as a lamp 56 or a light-emitting diode 57, for the backlighting of a display surface 58a, 58b of the control device 1 and for the generation of a circular diffuse light 58c around the control member 7 (FIGS. 1b, 2b and 3b).

To generate a circular diffuse light 58c around the control member 7, the peripheral skirt 17 of the control barrel 11 extends to the end of the control device 1 and leads from the control device 1 via an annular element surrounding the control member 7. The control barrel 11 thus makes it possible to transmit light from the lighting means 56 to the emerging annular element that can be seen by the users, allowing a better identification, notably when driving at night.

The display surface 58a, 58b comprises for example a film, that is opaque except for portions allowing the light to pass through, having the shape of a symbol and/or a sign. The symbol is for example a pictogram or a script in the form of an inscription of a letter or letters or of a figure or figures relating to the function to be controlled.

For example, and as can be seen in FIGS. 1b and 1d, the control member 7 comprises two display surfaces 58a, 58b and the base 3 has two lighting means 56 and 57 for the respective backlighting of the display surfaces 58a, 58c and 58b.

A first display surface 58a can be seen in FIGS. 1b and 1d, and it comprises pictograms representing various modes of distribution of the ventilation, which pictograms are backlit by a corresponding lamp 56 supported by the base 3 and a second display surface 58b forming an illuminated indicator, backlit by a corresponding light-emitting diode 57 and representing the engagement of the air conditioning.

The display surface 58a, 58b is supported by the control member 7 and is backlit depending on the control selected by the knob 5 and/or by the control member 7.

Therefore, for example the first display surface 58a is backlit depending on the distribution control selected by the control knob 5 and the second display surface 58b is backlit depending on the switching on or off control of the control member 7.

This arrangement makes it possible to secure the gripping ring 19 in rotation with the base unit 12 while leaving space inside the knob 5 for the electric wires or for the actuation means of the control member 7 to pass through.

Thus, it is possible to attach the electric and/or electronic elements and the actuation means of the control member 7 to the base 3.

This arrangement is possible because the knob 5 is mounted so as to rotate through less than 360°, the connecting bridge 18 not allowing a larger angle of rotation.

Another example of a control device 1 will now be described according to this first embodiment. This device 1 shown in FIGS. 2a to 2d allows the ventilation temperature to be controlled.

The device 1 comprises the same elements as the control device 1 for the distribution of the ventilation. Only the pictograms shown on the display surfaces 58a, 58b have different shapes.

In this new example, pushing in the control member 7 allows the user to switch on or off the rear window defrosting control of the vehicle and the control knob 5 allows the intensity of the ventilation temperature to be controlled.

The pictograms of the first display surface 58a form a series of segments inscribed in an arc of a circle exhibiting two different backlit colors corresponding to the hot and cold symbols for the ventilation temperature.

A second display surface 58b exhibits an illuminated indicator, backlit to represent the switching on of the defrosting control.

It can be understood therefore that the control device 1 for the ventilation mode (FIGS. 1a to 1d) can easily be adapted to a control device 1 for temperature (FIGS. 2a, 2b, 2c and 2d).

The control devices 1 therefore have control knobs 5 defining one and the same range of angular variation and a control member 7 defining one and the same number of switching states. Only the button 30 of the control member 7 must be modified to be representative of the specified control.

The control device 2 of FIGS. 3a to 4, produced according to a second embodiment, will now be described in greater detail.

The control member 7 of the second control device 2 comprises an electric rotary switch comprising a button 30 that is mounted and controlled by a rotary shaft 21 of the base 3.

The switch thus makes it possible to actuate power switches (not visible) provided for this purpose in the base 3, for example for controlling the intensity of the ventilation.

The rotary shaft 21 defines for example five different levels of ventilation intensity.

The second portion 40 of the axial tube 16 is configured to allow the rotary shaft 21 to pass through and forms an axial guide of the shaft 21.

The control knob 5 of the second control device 2 also comprises an adaptor 62 mounted so as to rotate on the rotary shaft 21 between the base 3 and the barrel 11.

The adaptor 62 is configured to transmit the rotary movement of the barrel 11 to the base unit 12 so that the adaptor 62 is secured in rotation to the control knob 5.

For this, the adaptor 62 is connected to the connecting bridge 18 of the knob 5.

The adaptor 62 also comprises a diverted guide 64 that is inserted into an opening 66 of the base 3 so as to allow the adaptor 62 to pivot by a pivoting movement of the diverted guide 64 in the opening 66.

The diverted guide 64 is designed to be attached to the rotary element 13 of the base unit 12 so that the rotary element 13 is secured in rotation to the control knob 5 and so that one end of the cable 15 of the base unit 12 can move with the diverted guide 64.

In this configuration, the base unit 12 has no shaft 20 as has the first control device 1.

The diverted guide 64 can therefore pivot through an angle of 90° defining two extreme angular positions of the control knob 5 corresponding, in this example, to two possible modes of air circulation in the vehicle.

The adaptor 62 therefore allows the diversion of the actuation of the base unit 12 connected to the control knob 5 so as to allow the rotary shaft 21 of the control member 7 to pass through without having to modify the control knob 5 of the first and of the second control device 1, 2.

The control member 7 also comprises a support 68 attached to the base 3, mounted concentrically in the control knob 5 and having a display surface 58a, 58b that can be backlit.

The support 68 comprises removable attachment means interacting with matching removable attachment means (not visible) of the base 3. For example, the support 68 comprises grooves 70a interacting with corresponding ribs (not visible) supported by the base 3.

The support 68 also comprises an orifice allowing the passage of the connecting bridge 18 over the angular range of rotation of the knob 5.

Therefore, a first display surface 58a of the support 68 can be seen in FIGS. 3a and 3b, comprising pictograms and figures representing the intensity of the ventilation and a second display surface 58b comprising pictograms representing the air circulation mode.

The display surface 58a, 58b is backlit depending on the control selected by the knob 5 and the control member 5, 7.

It can therefore be understood that the control device 1 having a push control member (FIGS. 1a to 2d) for controlling power switches can easily be adapted to a control device 2 with a rotary button (FIGS. 3a to 4).

The control devices 1, 2 therefore have a similar space requirement allowing them to be easily interchangeable in a control panel in which they no longer have a predetermined position.

Therefore, the control panel has a modular structure which comprises control devices having few parts and being able to be easily adaptable depending on the vehicle for which the control panel is intended.

This modular design makes it possible, based on a small number of basic control devices, to produce a large number of control panels of different types.

1. A control device (1, 2) for controlling functions on a motor vehicle control panel, said control device comprising a base (3), a control knob (5) mounted so as to rotate on the base (3) and being capable of interacting with a base unit (12) designed to be connected to an apparatus of the motor vehicle that must be controlled, and a control member (7) mounted concentrically in the control knob (5), characterized in that the control knob (5) comprises a gripping ring (19) and a control barrel (11) having, on the one hand, a peripheral skirt (17) interacting with said ring (19) and, on the other hand, an axial tube (16) connected to the skirt (17) by a connecting bridge (18).

2. The control device (1, 2) as claimed in claim 1, characterized in that the control barrel (11) is made of a material that transmits light and in that the base (3) comprises at least one lighting means (56, 57) for the backlighting of a display surface (58a, 58b) of the control device (1, 2) and for the generation of a circular diffuse light (58c) around the control member (7).

3. The control device (1, 2) as claimed in claim 2, characterized in that the display surface (58a, 58b) is supported by the control member (7) and is backlit depending on the control selected by the control knob (5) and/or by the control member (7).

4. The control device (1, 2) as claimed in claim 1, characterized in that the control member (7) comprises an electric push switch.

5. The control device (1, 2) as claimed in claim 1, characterized in that the control member (7) comprises an electric rotary switch.

6. The control device (1, 2) as claimed in claim 5, characterized in that the control knob (5) also comprises an adaptor (62) mounted so as to rotate on a rotary shaft (21) of the base (3), between the base (3) and the control barrel (11), configured to transmit the rotary movement of the control barrel (11) to the base unit (12).

7. The control device (1, 2) as claimed in claim 6, characterized in that the adaptor (62) comprises a diverted guide (64) that is inserted into an opening (66) of the base (3) so as to allow the adaptor (62) to pivot by a pivoting movement of the diverted guide (64) in the opening (66).

8. The control device (1, 2) as claimed in claim 5, characterized in that the control member (7) comprises a support (68) attached to the base (3), mounted concentrically in the control knob (5) and having a display surface (58a, 58b) that can be backlit.

9. The control device (1, 2) as claimed in claim 1, characterized in that the axial tube (16) has a first portion (36) forming a means for guiding the control knob (5) in rotation by being inserted into a matching collar (38) of the base (3).

10. The control device (1, 2) as claimed in claim 9, characterized in that the axial tube (16) has a second portion (40) formed by a narrowing of the first portion (36), configured either to be secured in rotation with a shaft (20) of the base unit (12), or to allow a rotary shaft (21) of the base (3) to pass through.

11. The control device (1, 2) as claimed in claim 1, characterized in that the control knob (5) and the control member (7) comprise removable attachment means interacting with matching removable attachment means of the base (3).

12. A control panel for a motor vehicle, characterized in that the control panel comprises at least one control device (1, 2) as claimed in claim 1.

13. A control panel for a motor vehicle designed for the control of air conditioning, characterized in that the control panel comprises two first control devices (1) for the respective control of the ventilation temperature function and of the distribution of the airflows inside an interior of the motor vehicle, and at least one second control device (2) for controlling the intensity of the ventilation and of the air recycling mode;
wherein the two first control devices (1) and the at least one second control device (2) are each as claimed in claim 1; and
wherein the control member (7) of the at least one second control device (2) comprises an electric rotary switch.

14. The control device (1, 2) as claimed in claim 2, characterized in that the control member (7) comprises an electric push switch.

15. The control device (1, 2) as claimed in claim 3, characterized in that the control member (7) comprises an electric push switch.

16. The control device (1, 2) as claimed in claim 2, characterized in that the control member (7) comprises an electric rotary switch.

17. The control device (1, 2) as claimed in claim 3, characterized in that the control member (7) comprises an electric rotary switch.

18. The control panel for a motor vehicle as claimed in claim 13, characterized in that the control member (7) of the two first control devices (1) comprises an electric push switch.

19. The control panel for a motor vehicle as claimed in claim 13, characterized in that, in at least one of the two first control devices (1), the axial tube (16) has a first portion (36) forming a means for guiding the control knob (5) in rotation by being inserted into a matching collar (38) of the base (3).
